(19) United States
(12) Patent Application Publication
(10) Pub. No.: US 2002/0155802 A1
(43) Pub. Date: Oct. 24, 2002

(54) Apparatus for use in making cuts in the abdominal skin of poultry carcasses

(76) Inventors: William R. Sorenson, Blue Springs, MO (US); Mitchell S. Stockton, Lawrence, KS (US)

Correspondence Address: HOVEY, WILLIAMS, TIMMONS & COLLINS, 2405 Grand, Suite 400, Kansas City, MO, 64108, US

(21) Appl. No.: 09/837,083

(22) Filed: Apr. 18, 2001

(51) Int. Cl. A22B 5/18

(52) U.S. Cl. 452/120

(57) ABSTRACT

In order to facilitate cutting of the abdominal skin of the carcass, the skin is stretched to a taut condition just prior to commencing a cut of the skin. In a preferred embodiment, such stretching is accomplished through the use of a cam-actuated flapper plate that engages the skin and draws it toward one leg of the carcass, maintaining it in such taut position throughout the cutting process. In an embodiment used for making an opening cut to the body cavity, the knife swings along a skewed path of travel relative to the line of symmetry between the backbone and keel bone of the carcass so as to produce an angled cut that avoids nicking the keel bone.

### TECHNICAL FIELD

The present invention relates to high speed, automated poultry processing and, more particularly, to improvements in the way in which cuts are made in the abdominal skin of the carcass, such as during vent cutting and making the opening cut into the abdominal cavity.

### BACKGROUND

The abdominal skin of a poultry carcass, covering the abdominal cavity that contains the entrails, is loose and flaccid. This condition sometimes causes difficulties in making accurate cuts in the skin without damaging the entrails, such as when the vent plug is being removed or the opening cut to the abdominal cavity is being made. Further, with known opening cut machinery, it is sometimes possible to nick the keel bone as the knife moves through its cutting stroke, which degrades the acceptability of the product in the eyes of the consumer.

### SUMMARY OF THE INVENTION

The present invention contemplates stretching the abdominal skin tight before making the cut and then maintaining the skin in a taut condition as the cutting action is carried out. This greatly facilitates severance of the skin and helps reduce the risk of accidentally cutting into entrails located close to the abdominal skin, since the cutting stroke can be more restricted and better controlled. Further, the present invention contemplates making an angled opening cut in the skin from the vent hole adjacent the backbone generally toward the keel bone, but at an oblique angle so that the path of travel of the knife is off to one side of the keel bone.

In a preferred embodiment of the invention, a stretcher is located in close proximity to one leg of the straddle bar that is straddled by the legs of the carcass. The stretcher comprises a plate-like, rigid flap that overlies the abdominal skin when the carcass is lifted up into its processing position. At the appropriate time, the flap is turned down into engagement with the skin and rotated through almost 90° of travel to pull the skin sideways toward one of the legs of the carcass. While the skin is thusly stretched taut, the cutter performs its cutting operation on the tight skin. Rotation of the stretcher between its standby and operated positions is effected by a stationary cam that engages a follower on the stretcher as the stretcher moves by.

Making the opening cut angled rather than parallel to an axis of symmetry between the backbone and keel bone of the carcass is accomplished by skewing the swing path of the knife relative to the carcass. Instead of swinging the knife along the axis of symmetry in a path of travel that is generally perpendicular to the back of the carcass, the knife is mounted in such a way that its cutting stroke is oblique to such axis and off to one side of the keel bone.

### BRIEF DESCRIPTION OF THE DRAWINGS

FIG. 1 is a top plan view of a processing machine constructed in accordance with the principles of the present invention and capable of carrying out the inventive methods;

FIG. 2 is a vertical cross sectional view through the machine taken substantially along line 2-2 of FIG. 1;

FIG. 3 is a vertical cross sectional view through the machine taken substantially along line 3-3 of FIG. 1;

FIG. 4 is an enlarged, fragmentary horizontal cross sectional view looking downwardly at the machine taken approximately mid-height thereof;

FIG. 5 is a horizontal cross sectional view through the machine at a slightly higher level than FIG. 4 and illustrating one of the ring segments of the carousel and its relationship to the holding fixtures;

FIG. 6 is an enlarged, fragmentary vertical cross sectional view through one of the straddle bars of a holding fixture illustrating also the abdominal skin stretcher and associated components, the stretcher being illustrated in its standby position;

FIG. 7 is similar to FIG. 6 but shows the stretcher in its operated position;

FIG. 8 is an enlarged, fragmentary, horizontal cross sectional view through the center of the machine taken substantially along line 8-8 of FIG. 3;

FIG. 9 is a transverse cross sectional view through one of the fixtures just above the knife illustrating the skewed relationship of the knife to the guide rods of the fixture;

FIG. 10 is a fragmentary vertical cross sectional view of the fixture taken substantially along line 10-10 of FIG. 9;

FIG. 11 is a fragmentary vertical cross sectional view through a fixture illustrating the manner in which the back stop is operated by a cam track of the machine;

FIG. 12 is a view of the fixture similar to FIG. 11 but illustrating how the degree of extension of the back stop is adjusted by raising or lowering the cam track that controls the lifting and clamping apparatus of the fixture;

FIG. 13 is a flat pattern of the cams for the machine illustrating critical points in the processing operation;

FIG. 14 is an enlarged, fragmentary cross sectional view through the lower cam track in FIG. 13 and taken substantially along line 14-14 of FIG. 13 to illustrate the manner in which a short section of the lower track is spring-loaded;

FIGS. 15-20 illustrate the fixture at various points in a cycle of operation;

FIG. 21 is a fragmentary vertical cross sectional view of a carcass mounted on one of the fixtures and illustrating the manner in which the carcass is oriented for processing; and

FIG. 22 is a plan view from the tail end of a carcass illustrating the approximate path of travel taken by the opening knife as it makes an angled opening cut in the carcass.

### DETAILED DESCRIPTION OF THE PREFERRED EMBODIMENTS

This invention is susceptible of embodiment in many different forms. While there is shown in the drawings and described in the specification certain preferred embodiments of the invention, it is to be understood that the present disclosure is only an exemplification of the principles of the present invention. There is no intent to limit the broad aspects of the present invention to the particular disclosed embodiments.

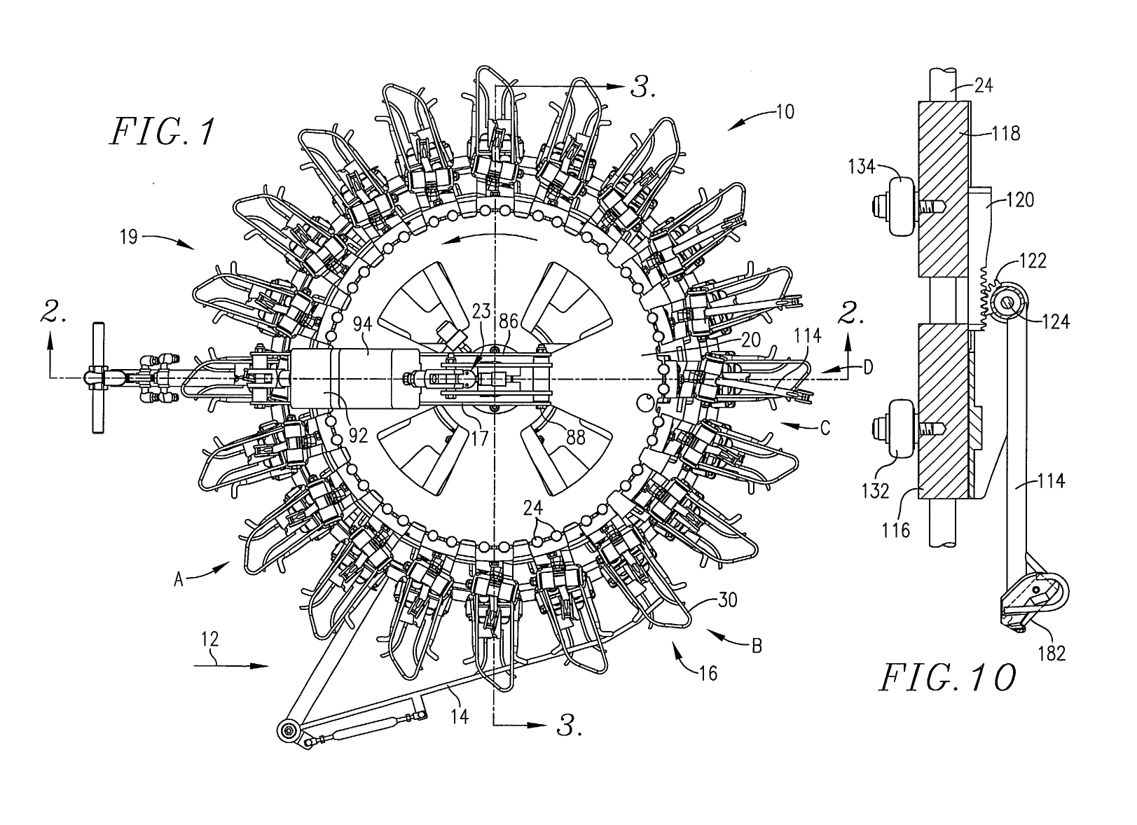

The machine 10 includes a carousel 19 adapted for rotation in a counterclockwise direction viewing FIG. 1, driven by an overhead conveying line that brings successive poultry carcasses hanging by their hocks to the machine in the direction of the arrow 12 in FIG. 1. Broadly speaking, the carcasses enter machine 10 behind the guide rail 14 and are intercepted by corresponding holding fixtures 16 spaced about the periphery of the carousel 19. Each fixture 16 receives a carcass, secures it into a properly located position, and maintains that control over the carcass as a processing operation is carried out thereon. Once the operation is complete and the fixture has rotated around to the far side of the machine, the fixture releases the carcass for conveyance by the overhead line to the next station in the processing facility. Although the particular machine 10 selected for purposes of illustration is an opener for making an opening cut into the abdominal cavity of the carcasses, it will be appreciated that certain principles of the present invention are not limited to that particular type of machine and may, in fact, be embodied in many different types of processing machines.

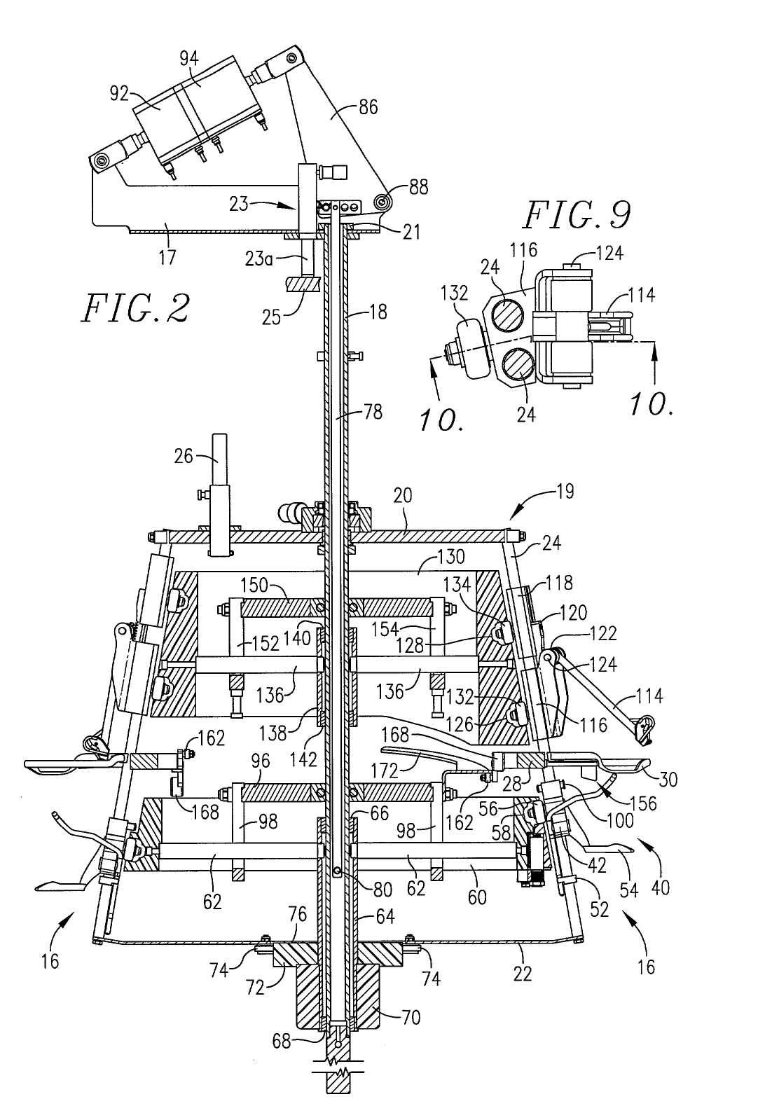

The carousel 19 is generally in the shape of a truncated cone as illustrated in FIGS. 2 and 3. A stationary, central tubular shaft 18 provides the main means of support for carousel 19 and defines its upright axis of rotation. A stationary, open, supporting framework (not shown) for shaft 18 and carousel 19 is located around the outside of carousel 19 and stands upright on the floor of the processing plant. Such framework supports a horizontally extending top channel 17 (FIGS. 2 and 3) at the upper end of the machine that serves as a means of suspending shaft 18 from the framework. The uppermost end of shaft 18 projects upwardly through the floor of channel 17 and has a nut 21 that bears the load of shaft 18 on channel 17. A hydraulic cylinder 23 (FIG. 2) fixed to channel 17 has its extendable ram 23a in load-bearing engagement with a member 25 of the framework to support channel 17. Channel 17 may lift or lower shaft 18 relative to the framework by extending or retracting ram 23a.

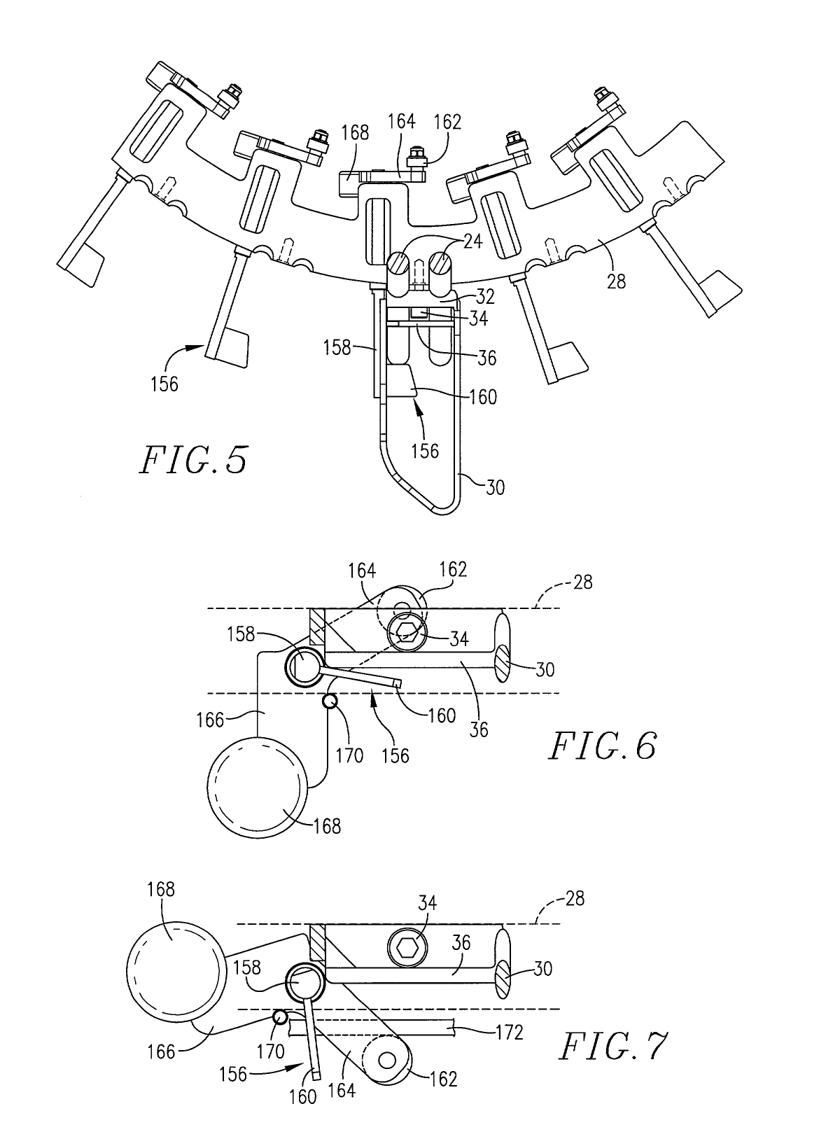

A top circular disk 20 of carousel 19 is rotatably supported upon shaft 18, while a larger diameter bottom plate 22 of the carousel rotates around shaft 18 adjacent the lower end of the machine. The top disk 20 and the bottom plate 22 are fixedly interconnected by multiple pairs of upwardly and inwardly inclined, circumferentially spaced guide rods 24 which in effect form a tapered sidewall of the carousel 19 and comprise part of the holding fixtures 16. An upstanding driver 26 on the top disk 20 (FIG. 2) is operably coupled with a drive wheel or the like (not shown) that is driven by the overhead conveying line such that the carousel is rotated at the same speed as the conveying line. A set of four horizontal, end-to-end ring segments 28 (detailed in FIG. 5) are bolted to the guide rods 24 along the interior surfaces thereof to serve as a means for supporting various components of the machine as will be further described. Thus, ring segments 28 rotate with carousel 19 about shaft 18.

In addition to the guide rods 24, each holding fixture 16 includes a horizontally disposed, generally loop-shaped straddle bar 30 that is fixed to the corresponding pair of guide rods 24 and to the corresponding ring segment 28 by a mounting bar 32 that is integral with straddle bar 30 and by a bolt 34 at the inboard end of straddle bar 30. The straddle bar 30 is straddled by the legs of the poultry carcass while the carcass remains suspended by its hocks from the overhead, moving conveyor line. A tail bar 36 spans the legs of the straddle bar 30 at a location spaced slightly outwardly from the mounting bar 32 to serve as a stop that abuts the tail end of the poultry carcass for locating purposes during operation.

Each fixture 16 further includes lifting mechanism 40 for lifting the carcass up against the straddle bar 30 and tail bar 36 and securely holding the carcass in such location as the opening cut is made in the abdominal skin of the carcass. In the preferred embodiment, lifting mechanism 40 is similar to that disclosed and claimed in U.S. Pat. No. 5,569,072 assigned to the assignee of the present invention. Accordingly, the '072 patent is hereby incorporated by reference into the present specification.

Briefly, lifting mechanism 40 includes a block 42 of synthetic resinous material that is reciprocally mounted on the guide rods 24. A pair of leg clamps 44 and 46 are mounted on block 42 for pivoting movement about respective pivots 48 and 50. A stationary cam bar 52 is fixed to the rods 24 below block 42 and is engaged with the lower ends of leg clamps 44 and 46. The lower ends of leg clamps 44 and 46 are so configured relative to cam bar 52 that as block 42 rises along guide rods 24, the upper ends of leg clamps 44 and 46 are caused to swing inwardly about pivots 48 and 50 to clamp against the legs and opposite sides of the trunk of the carcass immediately below the hip joints. This clamping action, coupled with the upward movement of the block 42, causes the carcass to be forced upwardly against the straddle bar 30 and the tail bar 36 and securely held in that position (see FIG. 21). When the block 42 is lowered on guide rods 24, cam bar 52 causes leg clamps 44 and 46 to pivot in the opposite direction, releasing their grip on the legs and trunk of the carcass. Block 42 also carries a fixed neck yoke 54 for receiving and controlling the neck of the carcass.

Up and down movement of the lifting block 42 along guide rods 24 is effected by a roller 56 on the rear of block 42 and by a cam track 58 that captively receives roller 56. Cam track 58 is formed in the outer circumferential periphery of an annular, lower cam cone 60 that encircles the upright shaft 18 and is held against rotation thereby. Cone 60 is supported by a plurality of radial spokes 62 (FIGS. 2 and 3) that are bolted to cone 60 at their outer ends and are fixed to a central hub 64 at their inner ends. Hub 64 encircles the lower end of shaft 18 and is adjustably reciprocal up and down along the latter by virtue of bushings 66 and 68 at upper and lower ends of hub 64. A clamp 70 at the lower end of hub 64 encircles the latter and supports a guide disk 72 provided with an outer circumferential surface upon which guide rollers 74 of bottom plate 22 ride for guidance during rotation of the carousel. A central opening 76 in bottom plate 22 is aligned with guide disk 72 so as to permit guide disk 72 to move up and down with hub 64 relative to bottom plate 22 during vertical adjustment of hub 64.

Hub 64 is raised or lowered along shaft 18 by a long link 78 housed within shaft 18. Link 78 carries a cross bolt 80 at its lower end that passes through vertical slots 82 and 84 in opposite sidewalls of shaft 18 and is fixed to hub 64. The upper end of link 78 is secured to a bell crank 86 that pivots about a horizontal pivot 88 on channel 17. Bell crank 86 is actuated by a pair of back to back air cylinders 92 and 94 extending between the outer end of bell crank 86 and a remote end of channel 17. In the preferred embodiment, bell crank 86 has four adjusted positions about pivot 88 corresponding to conditions where cylinders 92 and 94 are both fully retracted, both fully extended, cylinder 92 is retracted while cylinder 94 is extended, and cylinder 94 is retracted while cylinder 92 is extended. A lower stabilizer denoted generally by the numeral 96 is secured to shaft 18 above spokes 62 and has depending forks 98 that straddle a pair of the spokes 92 so as to help in holding cam cone 60 against rotation on shaft 18 during operation.

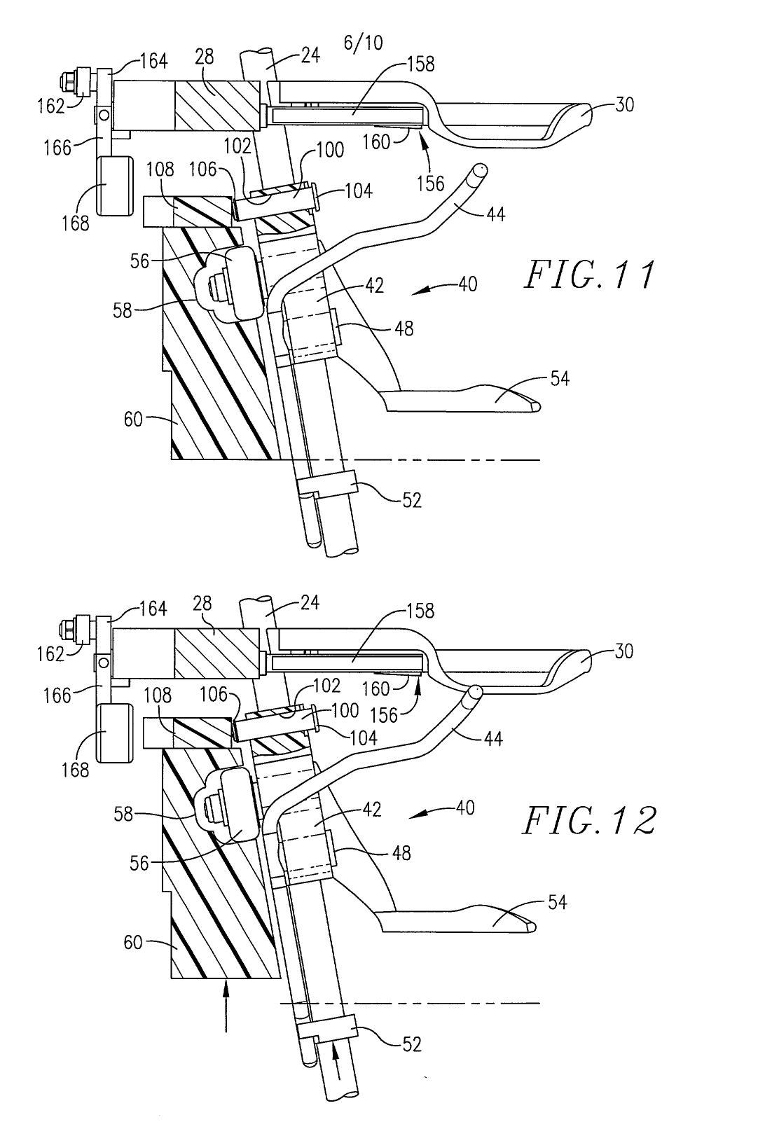

The block 42 of each lifting mechanism 40 is generally adapted to receive the back of the carcass on the fixture. The outer front face of block 42 is flat in the area of the pelvic bone structure of the carcass. In addition, however, the block 42 is provided with an adjustable back stop 100 in the nature of a stainless steel pin or plug that is received within a bore 102 in block 42 (FIGS. 11 and 12). Back stop 100 is shiftable within the bore 102 of block 42 along a line of action that is perpendicular to guide rods 24 and the path of up and down travel of block 42. An enlarged head 104 at the outer end of back stop 100 limits the retraction of back stop 100 to a position in which head 104 is essentially flush with the outer face of block 42. At the other extreme, a retaining ring 106 on the inner end of back stop 100 limits the amount of extension of back stop 100, i.e., the distance which head 104 projects outwardly beyond the surface of block 42.

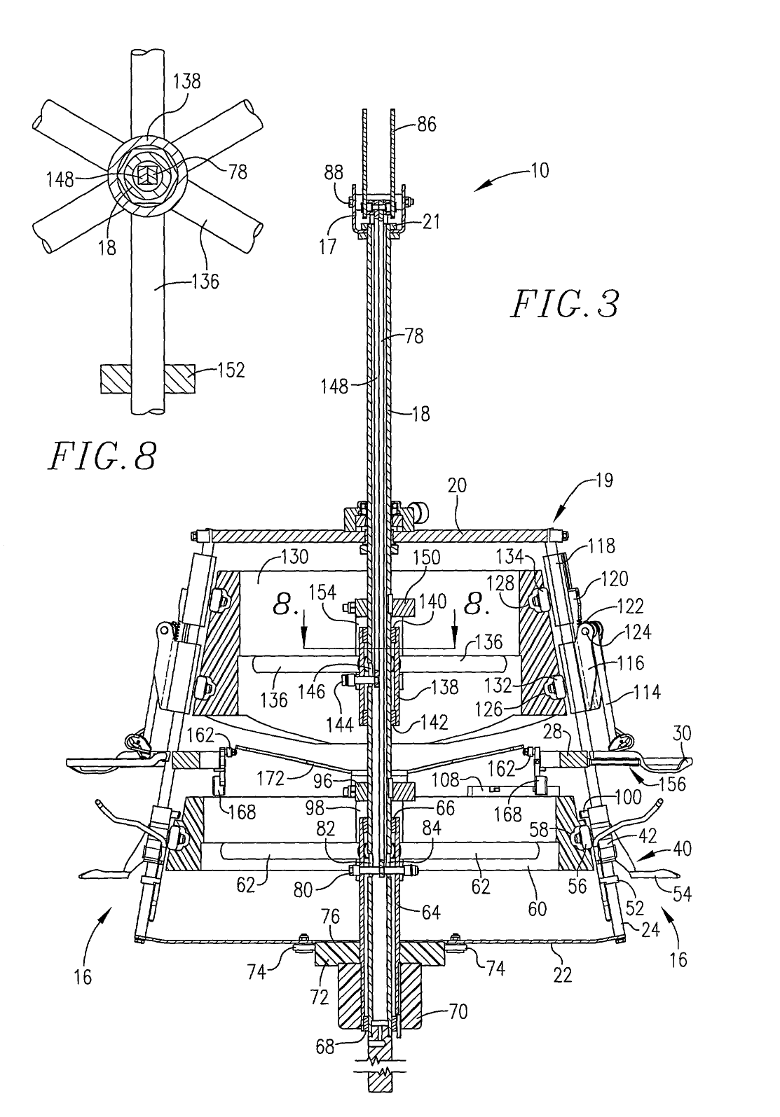

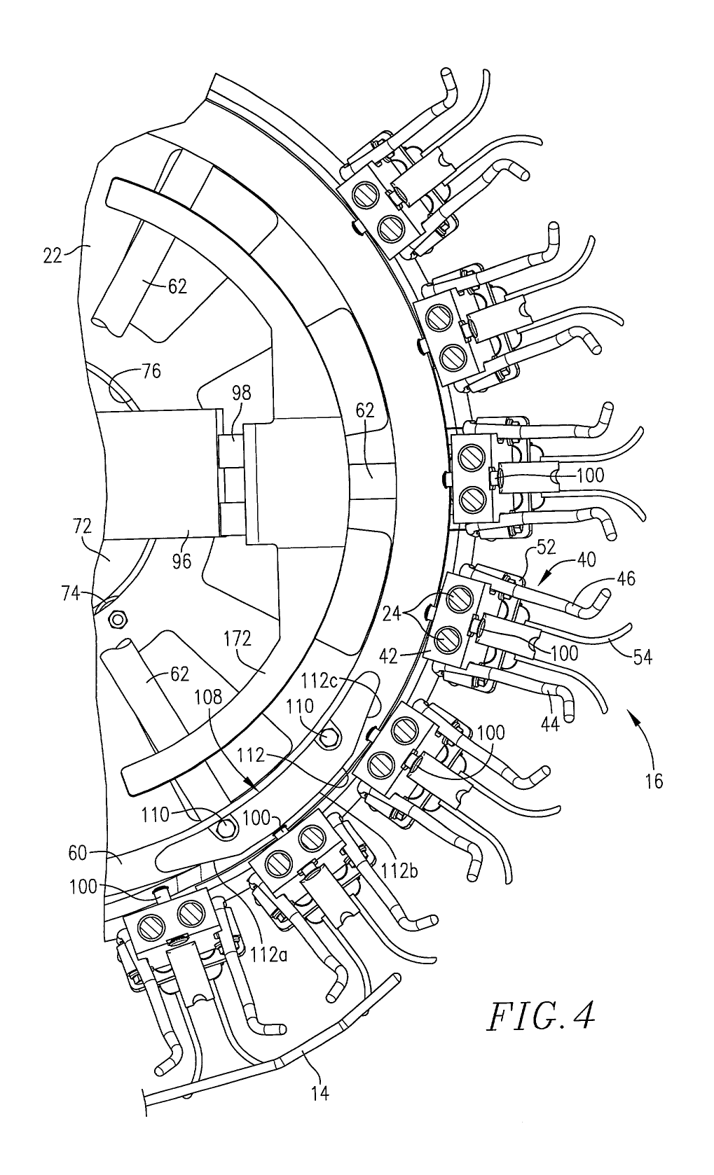

The back stop 100 is operated by a relatively short, generally arcuate cam segment 108 (see also FIG. 4) secured to the upper extremity of cam cone 60 by bolts 110. Cam segment 108 has an outboard, vertical cam surface 112 that is disposed to engage the innermost end of back stop 100 to project it from block 42. A beveled lead-in portion 112a of cam surface 112 causes progressive extension of back stop 100 from block 42, while a constant radius central portion 112b of surface 112 maintains the projected position of back stop 100. An oppositely beveled portion 112c of surface 112 at the exit end thereof permits the back stop 100 to be retracted by the body of the bird after it passes cam segment 108.

FIGS. 11 and 12 illustrate that when cam cone 60 is adjusted vertically to change the upper and lower limits of travel of the block 42, such vertical adjustment also has the effect of adjusting the throw, or amount of extension, of the back stop 100 from block 42. This is due to the fact that cam surface 112 of cam segment 108 is vertical, while the path of travel of block 42 is inclined. Consequently, as cam cone 60 and cam segment 108 are adjusted upwardly, cam surface 112 becomes disposed closer to the back side of block 42 than before, thus functioning to push back stop 100 further outwardly than prior to such adjustment. Similarly, when cam cone 60 and cam segment 108 are adjusted downwardly, the vertical cam surface 112 becomes spaced further away from the back side of block 42 to correspondingly push back stop 100 a shorter distance outwardly beyond the front face of block 42 during each actuation.

It will be seen, therefore, that the distance back stop 100 projects outwardly from block 42 is a function of the extent to which the path of travel of the block 42 is displaced upwardly or downwardly along the inclined guide rods 24. If the upper end of such path of travel is adjusted upwardly to account for smaller birds that are shorter in length, for example, the back stop 100 will correspondingly be projected further outwardly than before. Because smaller birds also have thinner backs it is necessary to position those carcasses further outwardly along the straddle bar 30 than larger carcasses in order to properly locate the vent hole for processing. On the other hand, if the upper limit of travel of the block 42 is adjusted downwardly along guide rods 24 by lowering guide cone 60 so as to accommodate larger carcasses, the back stop 100 will not be projected as far outwardly by cam segment 108 as it would prior to such adjustment. This allows the vent hole of the carcass to remain properly positioned.

In one preferred embodiment of the invention, the angle of inclination of the guide rods 24 is approximately 10°. The range of vertical adjustment of the cam cone 60 is 30 millimeters. Consequently, the range of adjustment of the outermost position of the back stop 100 is approximately 5.2 millimeters. In a typical processing situation, this range is adequate to compensate for variations in back thickness between larger and smaller birds typically processed by this machinery. It will be appreciated, however, that the principles of the present invention are certainly not limited to this range of values.

A processing tool denoted generally by the numeral 114 is mounted on guide rods 24 above each straddle bar 30 for performing a processing operation on the carcass held by the fixture 16. In the particular embodiment illustrated herein, as noted earlier, the processing tool is a cutter in the form of a knife for making an opening cut into the body cavity of the carcass through the abdominal skin. An alternative embodiment of processing tool 114 may comprise a vent cutter, for example, for cutting the vent from the carcass prior to making the opening cut. It will be appreciated that the principles of the present invention encompass both of such types of processing tools, as well as others specifically not mentioned herein.

The knife 114 in the illustrated embodiment is mounted on a carrier 116 that is shiftable up and down along guide rods 24. An actuating head 118 is reciprocable along guide rods 24 above carrier 116 for effecting a cutting stroke of knife 114 after the knife has been inserted into a hole at the vent of the carcass following proper positioning of the carcass by the back stop 100 and other mechanism. The actuating head 118 carries an elongated rack gear 120 that meshes with a pinion gear 122 on the upper end of knife 114 to cause in and out swinging of knife 114 about a pivot 124 when actuating head 118 is moved relative to carrier 116.

Movement of carrier 116 and actuating head 118 along guide rods 24, and movement of the actuating head 118 relative to carrier 116, are controlled by corresponding cam tracks 126 and 128 in the outer periphery of an annular upper cone 130 supported by central shaft 18. A following roller 132 on the back side of carrier 116 rides in track 126, while a following roller 134 rides within cam track 128.

Upper cam cone 130 is supported on central shaft 18 in the same way that lower cam cone 60 is supported on shaft 18. A plurality of radially projecting spokes 136 (FIG. 8) are fixed at their outer ends to the upper cam cone 130 and at their inner ends to a cylindrical hub 138 that surrounds central shaft 18. Hub 138 has a pair of upper and lower bushings 140 and 142 that adapt hub 138 for vertical sliding movement along shaft 18. A cross bolt 144 extends transversely through one side of hub 138 and through a vertical slot 146 in the corresponding side of shaft 18 before being threaded into the lower end of an upright link 148 within shaft 18 and disposed alongside link 78. Link 148 is connected at its upper end to bell crank 86 in the same manner as link 78 such that manipulation of crank 86 causes adjusting up and down movement of link 148 in addition to link 78. A stabilizer 150 fixed to shaft 18 above hub 138 has a pair of depending forks 152 and 154 that embrace two of the diametrically opposed spokes 136 to hold upper cam cone 130 against rotation relative to shaft 18 during operation.

As shown in FIG. 9, carrier 116 for knife 114 is configured in such a manner that the pivot 124 is skewed with respect to the line of centers between guide rods 24. Instead of extending parallel to rods 24, pivot 124 extends at an oblique angle of approximately 12.5° relative to rods 24. The rack gear 120 of actuating head 118 is similarly skewed so as to maintain proper meshing relationship with the pinion gear 122 on the upper end of knife 114.

As a result of this skewed relationship, the cutting stroke of knife 114 as it swings outwardly after being inserted into the vent hole of the carcass is not perpendicular to the line of centers between rods 24. Instead, it is at an oblique angle (12.5°) relative to such line of centers. As will be seen, this results in an angled opening cut in the abdominal skin of the carcass.

In order to assist in the making of the opening cut, each fixture 16 is provided with apparatus for drawing the abdominal skin tight just prior to the cut and for maintaining the skin in a taut condition while the cutting stroke of knife 114 is carried out. Such apparatus comprises a stretcher denoted by the numeral 156 (FIGS. 5-7) that is located closely adjacent and slightly below one leg of each of the straddle bars 30. Each stretcher 156 includes an operating shaft 158 located slightly below the adjacent leg of loop 30 and extending in parallel relationship therewith generally radially outwardly from the center of the carousel. At its outer end, shaft 158 is provided with a rigid, transversely extending, plate-like flap 160 that normally projects generally horizontally from shaft 158 laterally into the open space defined by loop 30. At its opposite, inner end, shaft 158 is journaled by ring segment 28 for oscillation about the longitudinal axis of shaft 158. During operation, stretcher 156 rotates between a standby position in which flap 160 extends generally horizontally (FIGS. 5 and 6), and an actuated position in which flap 160 projects downwardly after shaft 158 has been rotated almost 90 degrees (FIG. 7).

In order to operate stretcher 156, the inboard end of shaft 158 is provided with a cam follower roller 162 mounted on shaft 158 via a crank arm 164. An oppositely extending crank arm 166 supports a counterweight 168 at its outer end so that shaft 158 is biased toward the standby position of stretcher flap 160. A stop 170 carried by crank arm 166 abuts the bottom of ring segment 28 when flap 160 is in its standby and operated positions so as to prevent over travel of shaft 158 beyond such extreme positions.

Follower roller 162 of stretcher 156 is disposed for operation by an inclined cam 172 within the interior of the carousel (FIGS. 2-4). Follower roller 162 bears against the underside of cam 172, biased to that position by the counterweight 168. Cam 172 is generally semi-circular when viewed in plan (FIG. 4) and has a shallow general V-shape when viewed in elevation (FIG. 13). Thus, the opposite ends of cam 172 are high and the center is low such that the stretcher is actuated progressively from its standby position to its operated position, is maintained in its operated position for a short period of time, and is then progressively released back to its standby position. Cam 172 is fixed to and supported by the lower stabilizer 96.

Operation

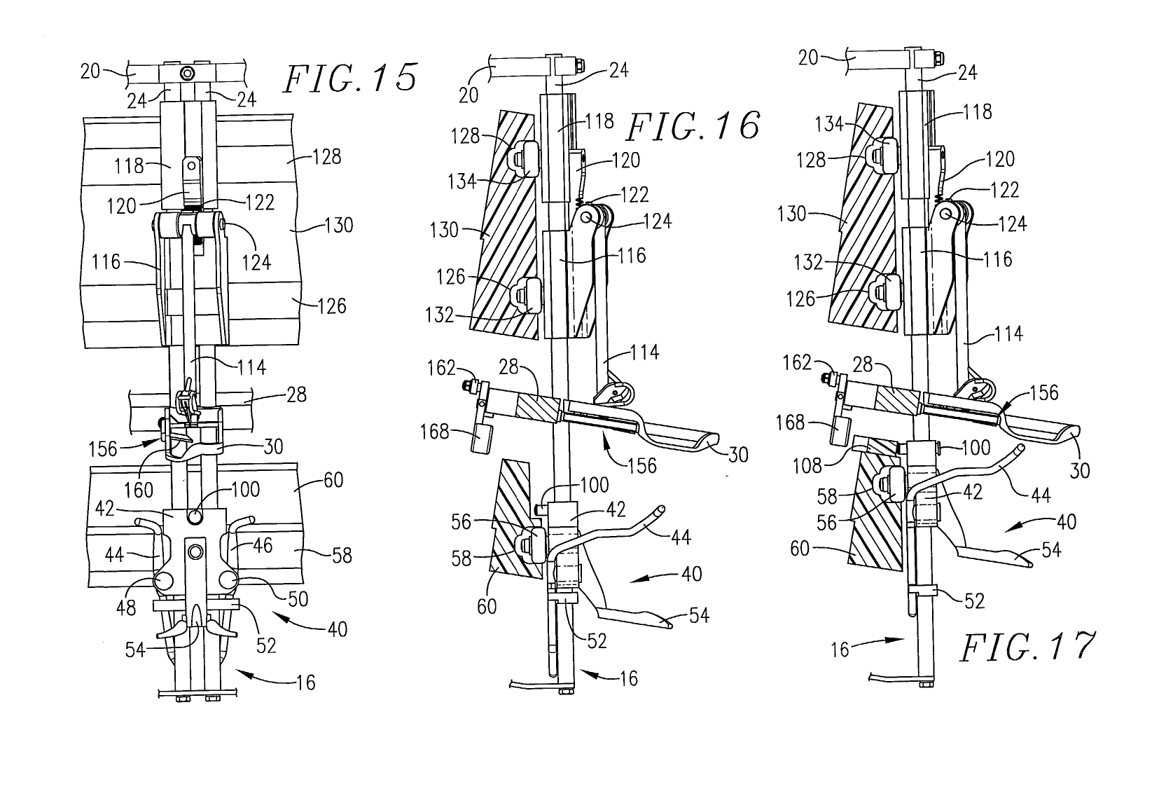

The empty fixtures 16 moving around the machine and approaching guide rail 14 in FIG. 1 correspond to the condition illustrated in FIGS. 15 and 16 in which the knife 114 is fully raised, the lifting and stabilizing mechanism 40 is fully lowered, the back stop 100 is fully retracted, and the stretcher 156 is in its standby position. This condition also corresponds to that designated by the letter A in FIG. 13 which shows one fixture 16 and a flat pattern of the various cam tracks for the machine as the fixture 16 moves around the central axis. It will be appreciated that condition A in FIG. 13 is typical of the fixtures 16 in FIG. 1 approaching the guide rail 14 where they will intersect with the poultry carcasses.

As the fixtures intercept the moving carcasses, the carcasses are guided into place with their legs straddling the straddle bar 30 and their backs up against the blocks 42 of the lifter mechanisms 40. By the time a fixture reaches position B in FIG. 1 and FIG. 13, the lifter mechanism 40 will have gripped the carcass on opposite sides of the trunk near the hip joints and will have lifted the carcass up against the tail stop 36 as illustrated, for example, in FIG. 21. This locates the carcass along a longitudinal axis 174 (FIG. 21) extending between the head and tail ends of the carcass.

Also by the time point B is reached, the back stop 100 will have engaged cam segment 108 and will have been pushed outwardly thereby along an axis 176 (FIG. 21) that is transverse to the carcass, extending generally between the back and breast of the carcass. Thus, by this time, the back stop 100 will have engaged the pelvic bone structure below the tail of the carcass and pushed the carcass outwardly away from the face of block 42 by an amount that is necessary to assure that the vent hole 178 is properly aligned with the tool 114. Depending upon the size of the birds being processed and the particular run at hand, the back stop 100 may be further extended than that illustrated in FIG. 21 or more retracted than that illustrated in FIG. 21, as determined by the vertically adjusted position of the cam cone 60.

At point B the cutter 114 has just started its downstroke toward the vent hole 178. Both the carrier 116 and the head 118 are moving downwardly at this time and in unison due to the downslope of their respective cam tracks 126 and 128. This condition is also illustrated in FIG. 17. At the same time, the following roller 162 of stretcher 156 starts under the cam 172, although cam 172 has no effect on stretcher 156 at this time.

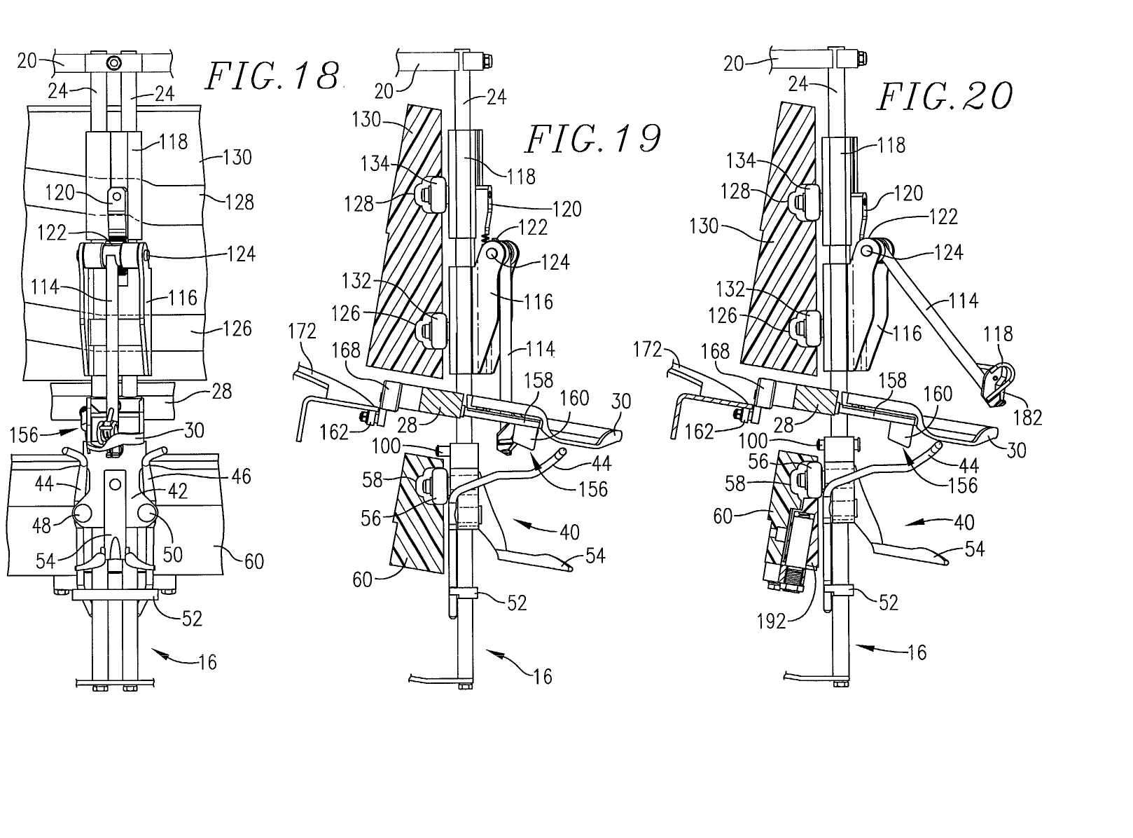

By the time point C is reached, the operating components are in the positions illustrated in FIGS. 18 and 19. By this time, the knife 114 has reached its lower limit of travel and has entered the vent hole 178 a short distance. Also by this time the stretcher 156 has been actuated so as to engage the abdominal skin 180 (FIG. 21) and pull it over toward one leg of the carcass. This has the effect of stretching the skin tight, in readiness for the cutting stroke of the cutter 114.

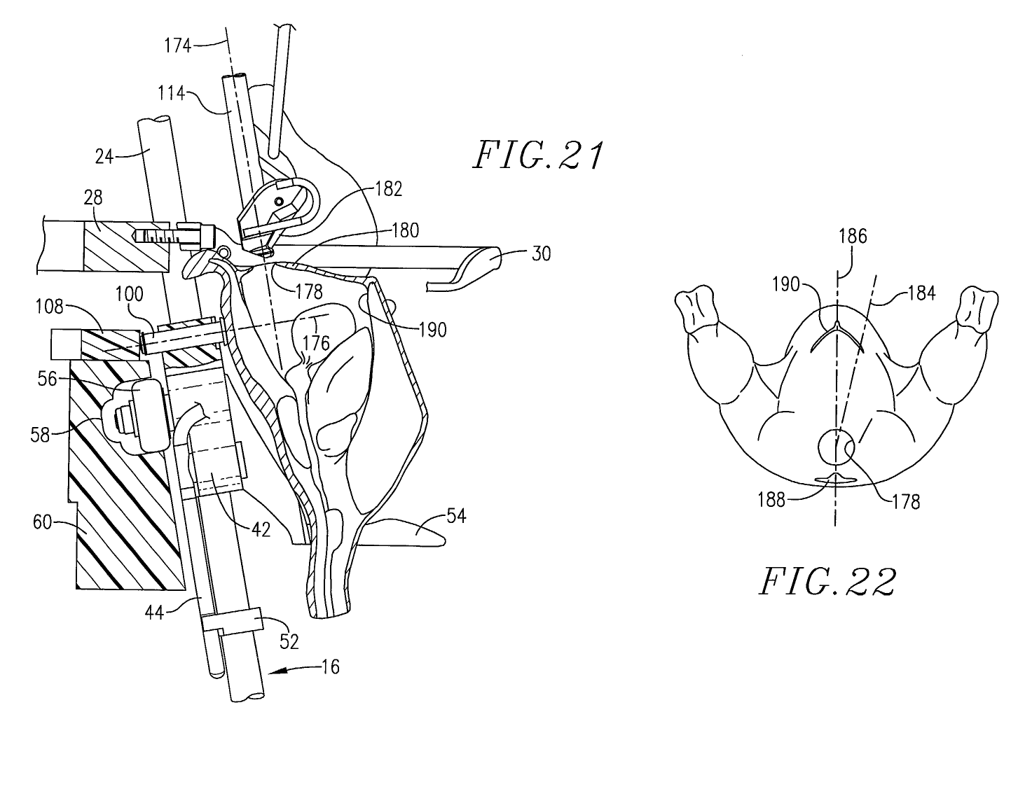

Between position C and position D, the stretcher 156 remains fully actuated so as to keep the abdominal skin in a taut condition. Cam track 128 for head 118 drops a short distance relative to cam track 126 for carrier 116. This causes the rack gear 120 to rotate pinion gear 122 in a counterclockwise direction viewing FIG. 10, thus causing knife 114 to flip out in its cutting stroke to the position shown in FIG. 20. During such stroke, the blade 182 on knife 114 slices cleanly through the taut abdominal skin 180 and makes an opening cut into the abdominal cavity. Because the pivot 124 is skewed with respect to the line of centers between the guide rods 24, knife 114 follows an oblique path of travel 184 as illustrated in FIG. 22, instead of a line of travel that is parallel to or common with the axis of symmetry 186 of the carcass extending between the back 188 and the keel bone 190. This causes the blade 182 of knife 114 to miss the keel bone and avoid damage thereto.

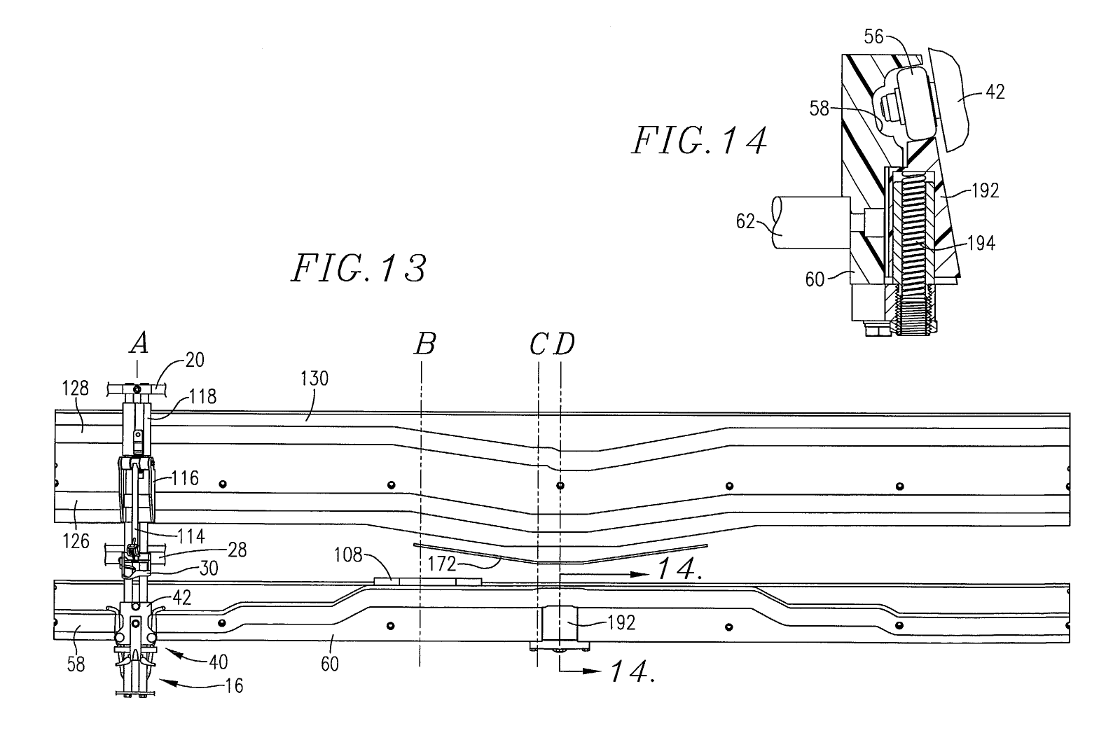

It will be noted that at position D the lowermost cam track 58 for lifter mechanism 40 has a spring biased segment 192 (FIGS. 13 and 14). Segment 192 is upwardly biased by a compression spring assembly 194 so that, in the event relief is needed at that instant due to an oversized bird, for example, the cam follower 56 can drop downwardly to provide relief. Similarly, the segment 192 pushes an undersized bird up for proper positioning.

After point D has been passed, the stretcher 156 is gradually released by cam 172 and returned to its standby position by the counterweight 168. Head 118 and carrier 116 progressively rise together to withdraw cutter 114 from the carcass, the rate of rise of the head 118 being slightly greater than that of the carrier 116 so that knife 114 is swung back down to its vertical, standby position. Thereafter, lifter mechanism 40 releases its grip on the carcass and retracts downwardly away from straddle bar 30, which allows the conveyor to pull the carcass away from the fixture and toward the next processing station.

It will be noted that the most critical time for positioning of the carcass with respect to the transverse axis 176 is just prior to and during insertion of the knife 114 into the vent hole 178. Once such insertion has been accomplished accurately, the back stop 100 is no longer needed. Therefore, just before position C, cam 108 for back stop 100 terminates all engagement with cam 100. The back stop 100 is then depressed by the weight of the bird back into its fully recessed position just prior to the time the opening stroke is actually made by knife 114.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

1. In a machine for processing a poultry carcass, the improvement comprising:
apparatus operable to hold the carcass;
a cutter operable to cut the abdominal skin of the carcass while the carcass is being held; and
a stretcher engageable with the abdominal skin during operation of the cutter to maintain the skin taut.

2. In a machine as claimed in claim 1,
said stretcher being operable to pull the skin toward one leg of the carcass to cause tightening of the skin.

3. In a machine as claimed in claim 1,
said stretcher comprising an operating shaft and a skin-contacting element projecting transversely from the shaft,
said shaft being rotatable about its longitudinal axis to pivot the element through a stretching motion in engagement with the skin generally toward one leg of the carcass.

4. In a machine as claimed in claim 3,
said element comprising a flat plate.

5. In a machine as claimed in claim 3,
said shaft having a cam follower on an end thereof remote from said skin-contacting element.

6. In a machine as claimed in claim 1,
said cutter comprising a knife movable into a hole adjacent the backbone of the carcass and then away from the backbone toward the keel bone in a cutting stroke to produce an opening cut into the abdominal cavity that extends from said hole toward the keel bone.

7. In a machine as claimed in claim 6,
said carcass having an imaginary line of symmetry intersecting the backbone and the keel bone while the carcass is held on said apparatus,
said cutting stroke of the knife extending at an oblique angle relative to said line of symmetry.

8. In a machine for processing moving poultry carcasses suspended by their hocks from a conveyor line, the improvement comprising:
a plurality of carcass holders movable in synchronism with the carcasses along a common path of travel and each operable to receive and hold a corresponding one of the carcasses during such movement;
a cutter movable along said path of travel with each holder and operable to cut the abdominal skin of the carcass on the holder;
a stretcher movable along said path of travel with each holder and operable to engage and maintain taut the abdominal skin of the carcass on the holder during operation of the cutter; and
cam structure adjacent said path of travel in disposition for operating the stretchers as they move along said path of travel.

9. In a machine as claimed in claim 8,
each stretcher being operable to pull the skin toward one leg of the carcass to cause tightening of the skin.

10. In a machine as claimed in claim 8,
each stretcher comprising an operating shaft extending generally perpendicular to the path of travel of the carcass holder and a skin-contacting element projecting transversely from the shaft,
said shaft being rotatable about its longitudinal axis to pivot the element through a stretching motion in engagement with the skin generally toward one leg of the carcass,
said shaft having a cam follower engageable with said cam structure.

11. In a machine as claimed in claim 10,
said element comprising a flat plate.

12. In a machine as claimed in claim 8,
said cutter comprising a knife movable into a hole adjacent the backbone of the carcass and then away from the backbone toward the keel bone in a cutting stroke to produce an opening cut into the abdominal cavity that extends from said hole toward the keel bone.

13. In a machine as claimed in claim 12,
said carcass having an imaginary line of symmetry intersecting the backbone and the keel bone while the carcass is held on said holder,
said cutting stroke of the knife extending at an oblique angle relative to said line of symmetry.

14. In a machine for making an angled opening cut in the abdominal skin of a poultry carcass, the improvement comprising:
apparatus operable to hold the carcass while the cut is being made,
said carcass having an imaginary line of symmetry intersecting the backbone and keel bone while the carcass is held on said apparatus; and
a knife movable into a hole adjacent the backbone and then generally toward the keel bone in a cutting stroke that extends at an oblique angle relative to said line of symmetry.

15. In a machine as claimed in claim 14,
said cutting stroke of the knife comprising a swinging stroke in which the knife swings about an axis extending obliquely with respect to said line of symmetry.

16. In a machine as claimed in claim 15,
said apparatus including a pair of horizontally spaced, upright guide rods, a stationary straddle bar between upper and lower ends of said guide rods, a back stop below said straddle bar having an outwardly facing surface that extends generally at right angles to said line of symmetry for engaging the back of the carcass, and a carcass lifter below the straddle bar movable on said guide rods toward and away from said straddle bar for forcing the carcass against the straddle bar and said back stop,
said knife being mounted on a support bracket above the straddle bar that is movable toward and away from the straddle bar along the guide rods,
said support bracket having a pivotal connection with said knife that defines said axis of swinging movement of the knife,
said axis of swinging movement of the knife extending obliquely with respect to said outwardly facing surface of the back stop.

17. In a machine as claimed in claim 16,
said apparatus further including a tail stop disposed for engagement with the rear end of the carcass in the vicinity of the tail.

18. In a machine for making an angled opening cut in the abdominal skin of moving poultry carcasses suspended by their hocks from a conveyor line, the improvement comprising:
a plurality of carcass holders movable in synchronism with the carcasses along a common path of travel and each operable to receive and hold a corresponding one of the carcasses during such movement,
each of said carcasses having an imaginary line of symmetry intersecting the backbone and keel bone while the carcass is maintained on its holder;
a knife movable along said path of travel with each of the holders and shiftable into a hole in the carcass adjacent the backbone and then generally toward the keel bone in a cutting stroke that extends at an oblique angle relative to said line of symmetry; and
cam structure adjacent said path of travel for operating the knife as the holders move along the path of travel.

19. In a machine as claimed in claim 18,
said cutting stroke of the knife comprising a swinging stroke in which the knife swings about an axis extending obliquely with respect to said line of symmetry.

20. In a machine as claimed in claim 19,
each of said holders including a pair of horizontally spaced, upright guide rods, a stationary straddle bar between upper and lower ends of said guide rods, a back stop below said straddle bar having an outwardly facing surface that extends generally at right angles to said line of symmetry for engaging the back of the carcass, and a carcass lifter below the straddle bar movable on said guide rods toward and away from said straddle bar for forcing the carcass against the straddle bar and said back stop,
said knife being mounted on a support bracket above the straddle bar that is movable toward and away from the straddle bar along the guide rods,
said support bracket having a pivotal connection with said knife that defines said axis of swinging movement of the knife,
said axis of swinging movement of the knife extending obliquely with respect to said outwardly facing surface of the back stop.

21. In a machine as claimed in claim 20,
each of said holders further including a tail stop disposed for engagement with the rear end of the carcass in the vicinity of the tail.

22. In a method of processing poultry carcasses, the improvement comprising:
moving poultry carcasses along a path of travel while the carcasses are suspended by their hocks;
stretching the abdominal skin of each carcass taut while the carcasses are moving; and while the skin is taut, cutting the skin.

23. In a method as claimed in claim 22,
said stretching step including the step of pulling the abdominal skin toward one leg of the carcass.

24. In a method as claimed in claim 22,
said cutting step including the step of making an opening cut to the abdominal cavity of the carcass from a hole adjacent the backbone of the carcass toward the keel bone.

25. In a method as claimed in claim 24,
each carcass having an imaginary line of symmetry intersecting the backbone and keel bone of the carcass,
said opening cut extending at an oblique angle relative to said line of symmetry.

26. In a method of preparing an opening to the abdominal cavity of poultry carcasses, the improvement comprising:
moving poultry carcasses along a path of travel while the carcasses are suspended by their hocks,
each carcass having an imaginary line of symmetry intersecting the backbone and keel bone of the carcass; and
cutting the abdominal skin of the carcass at an oblique angle with respect to said line of symmetry from a hole adjacent the backbone toward the keel bone.

27. In a method as claimed in claim 26; and
stretching the abdominal skin taut while the cutting step is carried out.

28. In a method as claimed in claim 27,
said stretching step including the step of pulling the skin toward one leg of the carcass.
